(19) United States
(12) Patent Application Publication
(10) Pub. No.: US 2025/0340486 A1
(43) Pub. Date: Nov. 6, 2025

(54) ONE-PART GEOPOLYMER COMPOSITION

(71) Applicant: THE UNIVERSITY OF STAVANGER, STAVANGER (NO)

(72) Inventors: Mahmoud KHALIFEH, HAFRSFJORD (NO); Mohamed Ahmed Fathy Abdelshafy OMRAN, STAVANGER (NO)

(21) Appl. No.: 18/870,335

(22) PCT Filed: May 30, 2023
(86) PCT No.: PCT/EP2023/064408

§ 371 Date: Nov. 27, 2024

(30) Foreign Application Priority Data
Jun. 1, 2022 (NO) 20220629

(51) Int. Cl. C04B 28/00; C04B 14/30; C04B 22/06; C04B 40/00; C04B 103/12

(52) U.S. Cl. CPC C04B 28/006; C04B 14/30; C04B 22/062; C04B 40/0039; C04B 40/0082; C04B 2103/12

(57) ABSTRACT

A powder mixture of a rock based geopolymer, zinc oxide and a solid activator is presented and the use of the same to produce cementitious materials by adding water or aqueous solution.

### FIELD OF TECHNOLOGY

The present invention relates to a powder mixture of rock based geopolymers, zinc oxide and a solid activator. The powder mixture may be used to produce a cement by simply adding water.

### BACKGROUND

The demand for Ordinary Portland Cement (OPC) is growing, which puts more challenges on the concrete industry. These challenges include decreasing limestone reserves and increasing carbon taxes. Governments are focusing on stimulating investment and innovation in these areas by supporting various research and adopting mandatory carbon emissions reduction policies. One of the main contributors to global carbon dioxide emission is OPC with up to 8% of the total global carbon dioxide emission. The released carbon dioxide emissions from OPC production are mainly originated from the de-carbonation of limestone and fuel used during calcination and production of cement. The development of alternative low-carbon, low-energy types of cement is viable to reduce the greenhouse effect. Geopolymers and alkali activated materials are among the listed construction materials that have the potential of reducing carbon dioxide emissions significantly. Investigations of costs and carbon emissions from geopolymers in comparison to OPC. As an observation, carbon dioxide emission from geopolymer is between 14 up to 97 wt. % less than OPC. The reasoning behind this large uncertainty is mainly originated from undistinguishing between geopolymers and alkali-activated based types of cement.

Geopolymers and alkali activated materials have been classified as the third-generation cement after OPC and lime. The term geopolymer is generally used to define partly amorphous and partly crystalline solid aluminosilicate materials in tetrahedral form, which are also known as inorganic polymers. Some researchers do not distinguish between geopolymers and alkali-activated cement. Geopolymers are low calcium content system consists of sialate monomers as repeating units (O—Si—O—Al—O). Several solid aluminosilicate materials such as feldspar, metakaolin, industrial residues, and solid wastes have been utilized as solid geopolymer precursors. However, these precursors have different reactivity depending on their chemical composition, mineralogy, morphology, and fineness. The main criteria for producing and developing stable geopolymer is the solid precursor should be amorphous or reactive, having consistent chemical composition, and low water content demand with water to solid precursor ratio less than 0.4.

Geopolymer could be designed to obtain desired mechanical properties compared to OPC, including higher acidic attack resistance, heat resistance, higher mechanical strength, and lower chemical shrinkage. Furthermore, it is important to prepare and select the proper type and dose of each component such as alkali-silicate activator, precursors, and admixtures. Moreover, geopolymer technology could be useful for allowing waste beneficiation route, known as circular economy, for using various industrial wastes and unused by-products. However, supply chain availability for geopolymer precursor materials, suitable admixtures for these materials, and examining protocols are still inadequate to be generalized and standardized globally. Binders were mainly formed from the chemical reaction between alkali activation source and solid aluminosilicate precursor.

Various types of raw materials have been utilized for synthesizing geopolymers, which may contain other types of synthetic powder precursors. In the context of geopolymer synthesis, the most commonly used materials as powder precursors are metallurgical slags and fly ash. Metallurgical slags such as blast furnace slags (Ground Granulated Blast Furnace Slag, GGBFS) are mixtures of poorly crystalline materials with depolymerized calcium silicate glasses to control the strength development profile as is done in OPC. Fly ash (FA) is a mixture of clay, sand and organic matter that are presented in coal, produced as a by-product during the combustion process. These compounds are melted in a furnace, and then being quenched rapidly in air to obtain small spherical particles.

In geopolymer synthesis, there are two main classes for FA that can be used, which are dependent on their calcium content; Class F contains low calcium according to ASTM C618, and Class C contains high calcium content. However, Class C FA is rarely utilized in geopolymer synthesis as Class C could be classified compositionally comparable to some mixtures of Class F and GGBFS. Moreover, fly ash class F and GGBFS mixtures are more preferred in the synthesis of geopolymers, where class C fly ash is less abundant than fly ash class F. There are still ongoing debates about nomenclature and terminology regarding geopolymers and alkali-activated materials in the literature. The former consists of a three-dimensional tetrahedral silica structure with more Q4 (2Al) and Q4 (3A1) centres, and low calcium content. However, the latter is characterized by lower silicon coordination, which is Q2 and Q2 (1Al), and higher calcium content.

Two-part (conventional) geopolymers are produced through a chemical reaction between concentrated alkali activation solution of alkali hydroxide, silicate, carbonate, or sulfate, and solid precursor of aluminosilicate as part two.

There is however as a result of logistical and environmental challenges regarding the usage of high alkaline or alkaline silicate solutions a need for one-part “just add water” geopolymers.

### SUMMARY OF INVENTION

The objective of the present invention is to overcome the drawback of the prior art and to present a one-part geopolymer, or “just add water” geopolymer. What the present inventors found was that by preparing a powder mixture comprising zinc oxide a geopolymer based cementitious material could be prepared by then adding water.

Geopolymers are inorganic materials forming long-chains of covalently-bonded molecules, for example silicon-oxygen bonds (—Si—O—Si—O—) and/or silicon-oxygen-aluminium bonds (—Si—O—Al—O—). They can be used for example as resins, binders, cements or concretes.

In a first aspect the present invention relates to a powder mixture as defined in claim 1.

In a second aspect the present invention relates to a method of preparing a cement wherein the method comprises
a. Mixing a geopolymer precursor, a zinc oxide, a solid activator and an aqueous solution to obtain a slurry; wherein the solid activator is selected from MOH, M₂SiO₃, or any combination thereof wherein M is selected from Li, Na and K; wherein the geopolymer precursor is rock based or is a mixture of geopolymer precursors comprising rock based geopolymer;
b. Curing the slurry at a first temperature.

In a third aspect the present invention relates to a kit comprising at least a first and a second container wherein the first container comprises the powder mixture according to claim 1 and wherein the second container comprises an aqueous solution preferably comprising an accelerator.

All embodiments disclosed herein may be combined and relates to all aspects of the present invention unless otherwise stated.

### BRIEF DESCRIPTION OF FIGURES

FIG. 1, The effect of water content on 1-Day UCS.

FIG. 2: The effect of chemical admixture CO on 1-Day UCS.

FIG. 3: The effect of chemical admixture C on 1-Day UCS.

FIG. 4: The effect of chemical admixture Z on 1-Day UCS.

FIG. 5: The effect of chemical admixture N on 1-Day UCS.

FIG. 6: The effect of various 0.14 wt % chemical admixtures on 1-Day UCS.

FIG. 7: The effect of various 0.14 wt % chemical admixtures on 7-Day UCS.

FIG. 8: UCA data for the neat recipe cured up to 28 days.

FIG. 9: The average UCS values versus UCA transit time for W1P.

FIG. 10: UCA data for the net recipe with two different water content, samples cured up to 7 days.

FIG. 11: UCA data for samples containing chemical admixtures.

FIG. 12: 1-Day, 7-Day, 28-Day, 56-Day and 112-Day UCS values for samples without (JAW), and with ZnO addition (JAW-Z), respectively.

### DEFINITIONS

The following terms are defined:

‘Cementitious’: a material that has the functional performance of a cement;

‘Geopolymer’: inorganic polymers comprising aluminosilicate;

‘Geopolymeric precursor’: solid particles in tetrahedral form which are reactive or can be activated to participate in geopolymerization;

‘Rock-based’: natural rocks which have reactive aluminosilicate components or can be activated through mechanical grinding, calcination or a combination of both;

‘Fly-ash based’: amorphous aluminosilicate materials produced when coal is burned;

‘Flag-based’: amorphous aluminosilicate materials with CaO and MgO content;

‘D’: darcy, unit for permeability, 1 darcy≈10⁻¹² m²; and

‘Portland cement’: a calcium alumina silicate compound that is manufactured from limestone and clay (or shale) with minor amounts of iron oxide, silica sand and alumina as additives where required to balance the mineral composition.

“Modular ratio”: denotes the molar ratio between SiO² and M₂O where M is a metal such as potassium or sodium.

“Anhydrous”: denotes that there is no free water however crystal water may be present.

“Essentially anhydrous”: denotes that there is essentially no free water however crystal water may be present. The amount of free water is preferably less than 0.5 wt %, more preferably less than 0.1 wt %.

### ABBREVIATIONS

OPC Ordinary Portland Cement
MPa Mega Pascal
GGBFS Ground Granulated Blast Furnace Slag
FA Fly Ash
P&A Plugging and Abandonment
UCS Uniaxial Compressive Strength
UCA Ultrasonic Cement Analyzer
XRD X-ray Diffraction
MR Modulus ratio
1P GP One-part Geopolymer
SS Sonic Strength
TT Transient Time
CO Calcium Oxide
C Calcium Carbonate
Z Zinc Oxide
N Sodium Hydroxide
M Alkali metal
K Potassium
Na Sodium
Li Lithium
mmol Millimoles
Q Quartz
A Albite
Mi Microcline
B Biotite
S1 Synthetic Potassium Aluminum Silicates Hydrates
S2 Synthetic Potassium Sodium Calcium Aluminum Silicate Hydrates
S3 Synthetic Sodium Calcium Magnesium Aluminum Silicate Hydrates
S4 Synthetic Potassium Zinc Aluminum Silicate Hydrates
W1Pb* W1Pb modified recipes with 0.14 wt % chemical admixtures

### DETAILED DESCRIPTION OF THE INVENTION

### Powder Composition

Today, most geopolymers and alkali activated based materials are two-part system i.e. a liquid hardener (e.g. dissolved sodium hydroxide) is mixed with precursors. The development of one-part geopolymers (OPG) or so-called “Just Add Water” are believed to have great potential as an alternative to ordinary Portland cement (OPC) and two-part geopolymer system. In the present invention, activator is used in solid form and is pre-blended with precursors; subsequently, water is mixed with the product and it sets. To accelerate or retard the reactions, chemical admixtures can be used. One-part geopolymers are more environmental and user-friendly materials. In addition, a one-part geopolymer system is more convenient to be utilized in cast-in-situ applications than the conventional two-part system. Such a product would then potentially not only be capable of being ultra-low CO2 intense but also can facilitate their commercialization and large-scale application in petroleum and civil engineering sectors.

According to the first aspect of the present invention the powder mixture comprises a geopolymer precursor, zinc oxide and a solid activator selected from a hydroxide or a silicate of lithium, sodium or potassium. The geopolymer precursor is rock based or is a mixture of geopolymer precursors comprising rock based geopolymer. It was surprising to the inventors to see that adding zinc oxide enhanced the condensation mechanism by balancing charges and lead to higher heat evolution. This in turn resulted in faster setting of the final product. A further advantage was that better short-and long-term strength development was seen without jeopardizing the pumpability. A further advantage was that at relatively short curing periods (such as 1-Day or 7-Days) high compressive strengths were obtained.

As seen in the examples the addition of zinc oxide drastically increases the mechanical strength of the obtained cementitious material in comparison with the neat recipes and in comparison with other additives. The amount of zinc oxide in the powder mixture is in one embodiment 0.05-6wt %, preferably 0.08-3 wt %, more preferably 0.08-2 wt % based on the total dry weight of the powder mixture. An advantage of using zinc oxide is that the effect is even seen at low amounts.

The amount of geopolymer precursor in the powder mixture is preferably at least 60 wt % on a dry matter basis, preferably 60-90 wt %, more preferably 70-85 wt % based on the total dry weight of the powder mixture. These amounts in combination with the other amounts of the constituents of the powder mixtures is believed to result in powder mixtures which results in the best cementitious materials. Geopolymer precursor is in the form of a powder of particles where the average particle size is preferably ≤100 μm, more preferably ≤63 μm, more preferably ≤53 μm, more preferably ≤20 μm.

Solid activator is selected from MOH, M₂SiO₃ and any combination thereof where M is selected from lithium, sodium and potassium. Preferably the solid activator is M₂SiO₃ and most preferably the solid activator is potassium silicate. This activator showed unexpected improved mechanical properties. The molar ratio between SiO₂ and M₂O where M is a metal of the solid activator is preferably 2.0-3.9, preferably 2.0-2.5, more preferably around 2.4. The amount of solid activator in the powder mixture is preferably 10-40 wt %, more preferably 10-30 wt %, more preferably 10-25 wt % based on the total weight of the dry weight of the powder mixture. In one embodiment the solid activator is M₂SiO₃ with a molar ratio of 2.0-2.5 and where the amount of the activator in the powder mixture is 10-30 wt %.

In order to obtain a good curing mixture, the weight ratio between zinc oxide and solid activator to geopolymer precursor should preferably be 0.05-0.4, more preferably 0.1-0.3, more preferably 0.15-0.25, more preferably 0.18-0.22. In embodiment the solid activator is M₂SiO₃ with a molar ratio of 2.0-2.5 and wherein the weight ratio between zinc oxide and solid activator to geopolymer precursor is 0.1-0.3.

In order to accelerator the curing or setting of the powder a solid accelerator may be added to the powder mixture. In one embodiment the accelerator is MOH wherein M is selected from Li, Na and K and the concentration of the solid accelerator preferably is in a range of 1-10 wt %, more preferably 2-8 wt % based on the total dry weight of the powder mixture. Without being bound by theory the present inventors believes that MOH may act as both an activator and accelerator. These amounts of accelerator are in addition to the amount of activator.

The powder mixture according to the present invention is essentially anhydrous in order to avoid pre-mature curing of the powder mixture. The salts and solid components of the present powder mixture may contain crystal water but the powder composition is essentially free of any free water. The amount of free water in the powder composition is preferably less than 0.5 wt %, more preferably less than 0.1 wt %.

### Method of Producing Cementitious Material

The present inventors found that cementitious materials from a mixture of geopolymer precursors, zinc oxide and a solid activator may be formed by just adding water as disclosed above.

By using zinc oxide in the powder the use and transportation of high alkaline or alkaline silicate solutions is removed and instead water or an aqueous solution may be added to prepare the cementitious material.

According to the present invention the method of preparing a cementitious material comprises the step of mixing a geopolymer precursor, a zinc oxide, a solid activator and an aqueous solution to obtain a slurry. The solid activator is selected from MOH, M₂SiO₃, or any combination thereof wherein M is selected from Li, Na and K and the geopolymer precursor is rock based or is a mixture of geopolymer precursors comprising rock based geopolymer. The slurry is the cured at a first temperature. The mixing may be done using any suitable means for mixing and is preferably done until a homogenous slurry is obtained.

In one embodiment the method comprises the step of providing the powder mixture according to the present invention and then mixing said powder mixture with an aqueous solution to obtain the slurry.

In yet another embodiment the geopolymer precursor and the solid activator is first mixed to obtain a powder blend where after the aqueous solution is added to the blend followed by the addition of the zinc oxide to form the slurry.

Curing of the slurry may be done at any suitable temperature and in one embodiment the first temperature is 4 to 600° C., preferably 10-250° C., more preferably 10-150° C. The aqueous solution is preferably water where the water may be water of any grade of purity. In one embodiment the aqueous solution comprises an accelerator preferably selected from lithium hydroxide, sodium hydroxide and potassium hydroxide or any combination thereof. When the aqueous solution comprises an accelerator the concentration of the accelerator is preferably is at least 4 M, preferably at least 10 M, more preferably at least 12 M. The amount of aqueous solution used in the method is preferably 20-50 wt %, more preferably 25-40 wt % based on the total weight of the dry weight of the powder mixture. This provides a good viscosity and pumpability as well as good mechanical properties of the obtained material.

In one embodiment the method is to prepare a cementitious material using the powder mixture according to the present invention.

### The Kit

A kit according to the present invention comprises at least two containers, a first container and a second container. The first container comprises the powder mixture according to the present invention and the second container comprises the aqueous solution which may be water or an aqueous solution comprising an accelerator. The amount of aqueous solution is preferably 20-50 wt %, more preferably 25-40 wt % based on the total weight of the dry weight of the powder mixture.

The accelerator is preferably selected from lithium hydroxide, sodium hydroxide and potassium hydroxide or any combination thereof, and wherein the concentration of the accelerator preferably is at least 4 M, preferably at least 10 M, more preferably at least 12 M.

In one embodiment the powder mixture of the first container is the powder mixture according to the present invention.

### EXAMPLES

### Example 1

In this work, the solid phase includes precursors, solid activator, and admixtures. The liquid phase includes distilled water and accelerator. Precursors are composed of rock or by-product materials, while potassium silicate anhydrous powder with modular ratio (MR) 3.92 was utilized in this study as a solid activator. Four admixtures were used separately in this study are sodium hydroxide pellets, calcium carbonate powder, calcium oxide powder and zinc oxide powder. Furthermore, potassium hydroxide solution (12 M) was utilized as an accelerator. Table 2 shows the chemical composition of the neat recipe (Granite is an aluminosilicate material, GGBFS is a calcium- and magnesium-rich material, and microsilica is a pure amorphous silicate material) as a mixture of these three precursors in weight percentage.

### 2.1 EXPERIMENTAL EQUIPMENT

A high-shear cement blender, the OFITE Model 20 Constant Speed Blender, was used for mixing all the components to form the slurry in each experiment. All samples were cured at atmospheric pressure in the oven at 70° C. Plastic cylindrical molds and lids were used for curing the samples. A cutter machine was used to flatten both ends of the cured samples. The dimension of the cured samples for uniaxial compressive strength test was about 51 mm diameter and about 80-85 mm height.

The test was performed in accordance with the American Petroleum Institute (API) standards API 10B-2, Chapter 7. The specimens placed under compression using Toni Technik-H mechanical tester as equipment and the loading rate applied on the samples was 10 kN/min.

### 2.1.1 API Mixer

A high-shear cement blender, the OFITE Model 20 Constant Speed Blender, was used for mixing all the components to form the slurry in each experiment.

### 2.1.2 Curing of Samples

All samples were cured at atmospheric pressure in the oven at 70° C. Plastic cylindrical molds and lids were used for curing the samples. A cutter machine was used to flatten both ends of the cured samples. The dimension of the cured samples for uniaxial compressive strength test was about 51 mm diameter and about 80-85 mm height.

### 2.1.3 Uniaxial Compressive Strength (UCS)

The test was performed in accordance with API 10B-2, Chapter 7. The specimens placed under compression using Toni Technik-H mechanical tester as equipment and the loading rate applied on the samples was 10 kN/min.

### 2.1.4 Sonic Strength

To measure sonic strength of the materials, Chandler ultrasonic cement analyzer (UCA) model 4265-HT was employed to measure sonic strength development by use of sonic impedance at 2000 psi and 70° C. for 7 days. The equipment is designed and calibrated to test OPC. Therefore, for any new material, new algorithms should be generated and applied in the custom algorithm option. The same equipment was used for all the materials to minimize any error in the system.

### 2.1.5 Compositional Analysis

The crystalline phases of the sample were analyzed by a Bruker-AXS Micro-diffractometer D8 Advance, which uses CuKα radiation (40.0 kV, 25.0 mA) with a 2θ range from 5° to 92° with 1o/min step and 0.010° increment. Fractured samples from the UCS test were dried in an oven at 50° C. overnight.

Afterwards, these specimens were kept in a vacuum dryer for one day to maximize the removal of water particles. The crystalline components were identified using the intensity of the observed diffraction as a function of the angle. As the chemical composition of the mixtures is complex and minor differences can occur due to sample preparation and random distribution of minerals, only the main peaks of the XRD patterns have been considered.

### 2.2 EXPERIMENTAL PROCEDURES

The candidate recipes were mixed in laboratory according with the recommended procedures. The mixing procedure for investigated all recipes where the precursor was mixed according to the suggested recipe including chemically normalized natural occurring rock. The activator was potassium silicate anhydrous powder with modular ratio (MR=SiO2/K2O) of 2.4 after the addition of potassium hydroxide 12 M solution as an accelerator. The slurry was prepared in accordance with API RP-10B-2 standard using the high-speed commercial blender OFITE Model 20 Constant Speed Blender.

### 2.2.1 Mixing

Mix design entails preparing the solid and liquid phases of the neat recipe, with and without adding admixtures to the solid phase, and at the end, combining all of them by blending. First, having obtained enough components, solids and liquids are mixed separately in a clean bucket and plastic container, respectively. Regarding admixtures, for each experiment, each admixture in powder form between 0.14 to 1.14 wt % equivalent to solid precursor, was added to the solid phase in the initial mix design. Table 1 presents the type and total amount of additives added to the rock-based geopolymer with their recipes' names.

TABLE 1
Mix design for the given rock-based 1P GP.

| Mix design name*^{1, 2} | Additives (wt. %) | Additives in millimoles |
|---|---|---|
| WIP*³ | Non | Zero |
| W1Pb | Non | Zero |
| W1Pb-CO2 | 0.14 wt % CaO | 35.71 |
| W1Pb-CO4 | 0.57 wt % CaO | 71.43 |
| W1Pb-CO6 | 0.86 wt % CaO | 107.14 |
| W1Pb-CO8 | 1.14 wt % CaO | 142.86 |
| W1Pb-C2 | 0.14 wt % CaCO3 | 19.98 |
| W1Pb-C4 | 0.57 wt % CaCO3 | 39.96 |
| W1Pb-C6 | 0.86 wt % CaCO3 | 59.94 |
| W1Pb-C8 | 1.14 wt % CaCO3 | 79.92 |
| W1Pb-Z2 | 0.14 wt % ZnO | 24.57 |
| W1Pb-Z4 | 0.57 wt % ZnO | 49.14 |
| W1Pb-Z6 | 0.86 wt % ZnO | 73.71 |
| W1Pb-Z8 | 1.14 wt % ZnO | 98.28 |
| W1Pb-N2*⁴ | 0.14 wt % NaOH | 50.03 |
| W1Pb-N4*⁴ | 0.57 wt % NaOH | 100.07 |

*¹All recipes had the same Activator and Accelerator to Solid precursors ratio, 0.20.
*²All recipes had the same free water content, 88.19 wt. % in liquid phase.
*³W1P has 35 wt. % liquid to solid ratio. However, the rest has 33 wt. % liquid to solid ratio.
*⁴The addition of NaOH pellets was considered as a partial substitution to the KOH solution to conserve MR = 2.4.

### 3. RESULTS AND DISCUSSION

### 3.1 Uniaxial Compressive Strength Test (UCS)

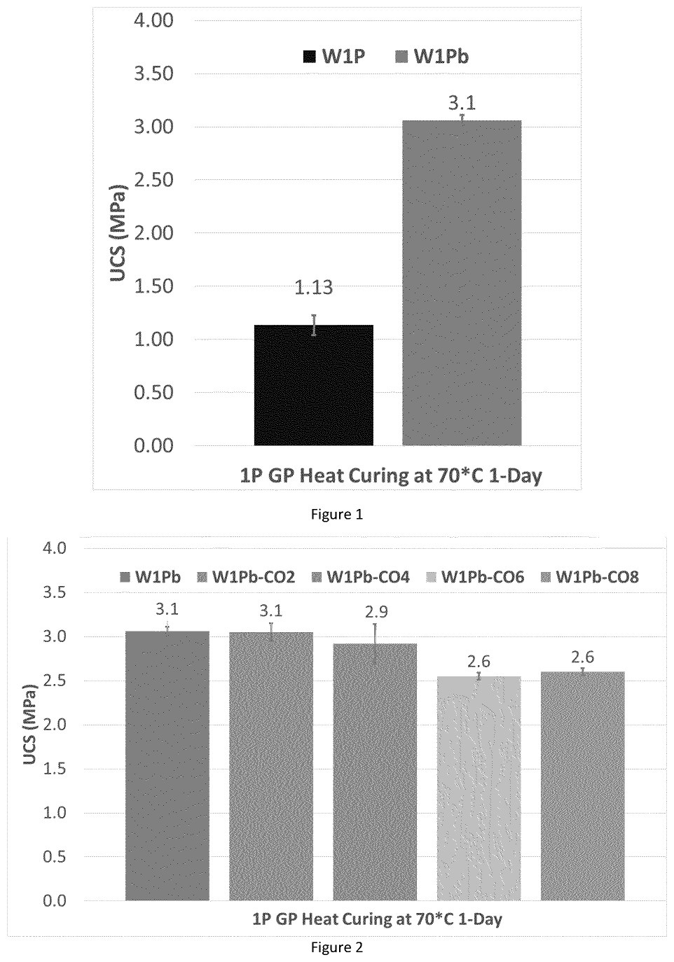

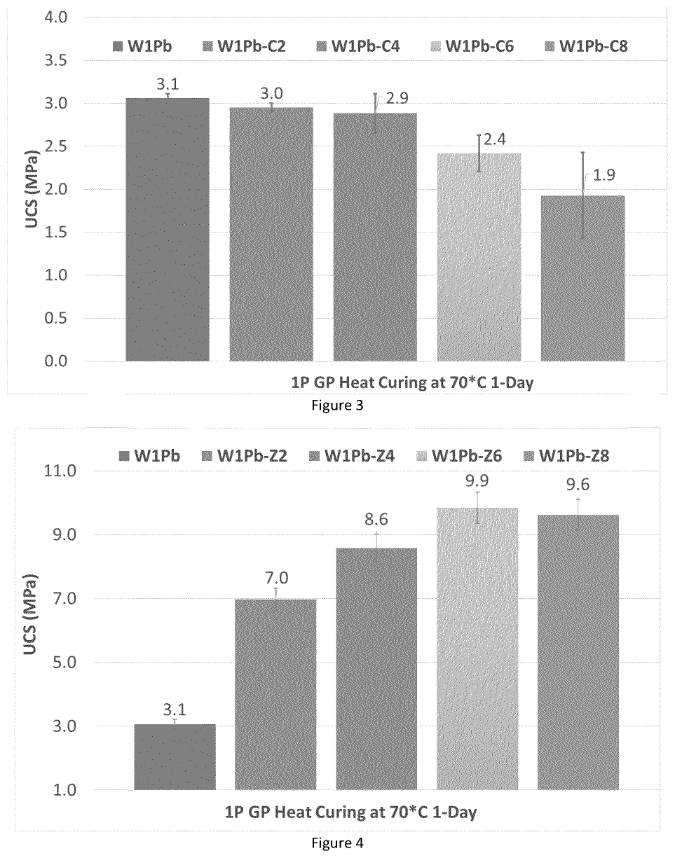

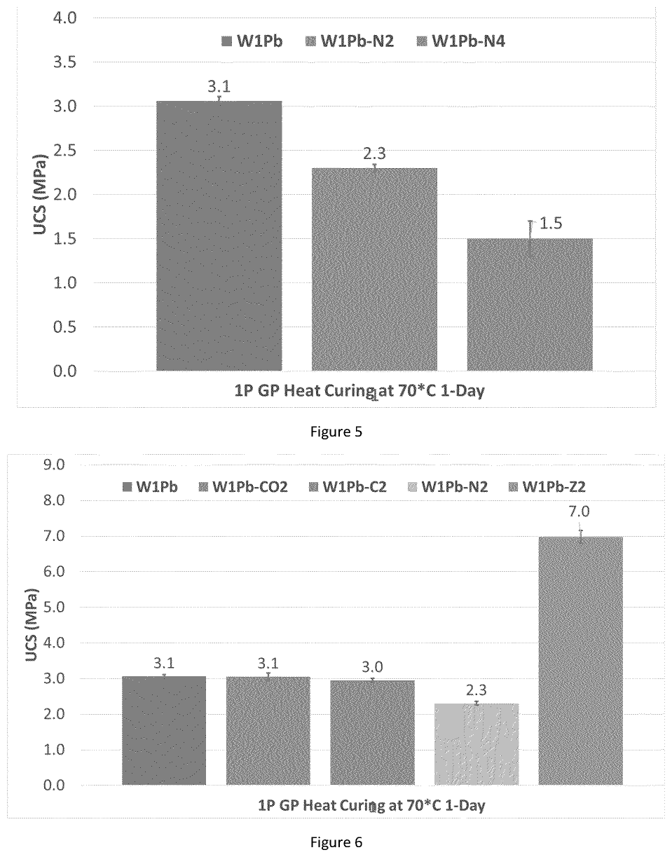

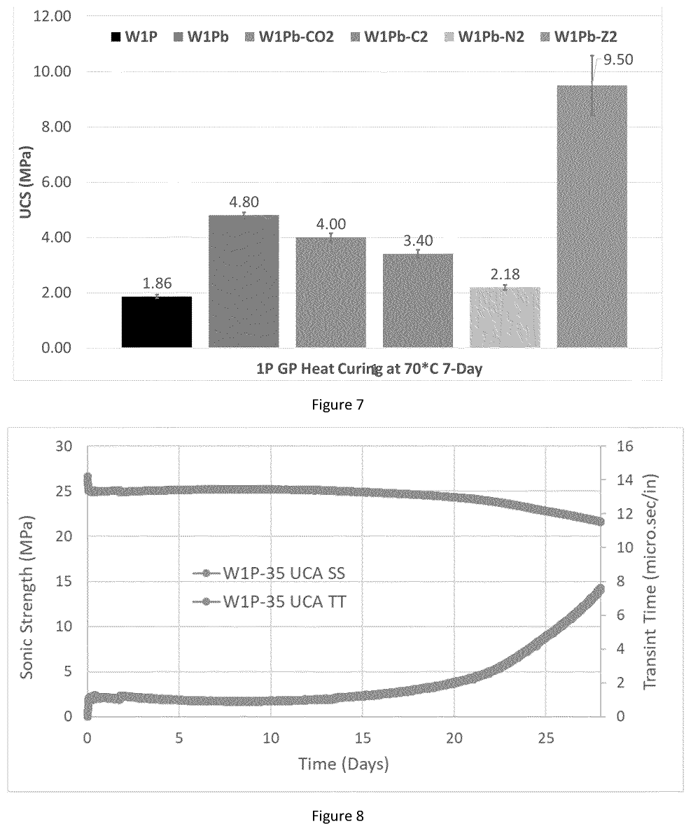

All recipes in Table 1 were investigated for UCS, each recipe includes three samples for each mix design, were prepared and cured at 70° C., at atmospheric pressure. All samples were tested after 1-day of curing. Furthermore, the top 1-day UCS recipes were also investigated after 7-day of curing. FIGS. 1 to 5 present the average compressive strength of the materials given in Table 1 after 1-day curing period. Moreover, the top comparable recipes (with 0.14 wt % chemical admixture) from 1-day UCS results in addition to W1P (W1P-35%) were selected for further investigation for 7-day UCS data as shown in FIGS. 6 and 7, respectively. One should note that 1-day strength development (10 MPa) is critical for drilling purposes. Therefore, it was considered in this work.

Uniaxial compressive strength results show the effect of water content on the given 1P rock-based GP as shown in FIG. 1 by comparing W1P (35% w/s, black color bar) vs W1Pb (33% w/s, grey color bar). The higher the water content the lower the 1-day and 7-day UCS. W1Pb has almost triple the UCS value of W1P in agreement with the negative effect of water content on geopolymer in literature. And then various chemical admixtures were added to the neat recipe to investigate each chemical admixture and its content on the 1P rock-based GP.

A trend was obvious to be detected as the higher the content of chemical admixture the lower the 1-day UCS for chemical admixtures CaO, CaCO₃ and NaOH. Therefore, at higher chemical admixtures content, it has also negative effect on 1-day UCS and early strength development.

In case of the addition of 0.14 wt % chemical admixture NaOH had a severe decrease in 1-day UCS that was observed to loss one third UCS of the neat recipe W1Pb. The addition of 0.57 wt % decreased 1-day UCS down to two third of the neat recipe W1Pb. This could happen due to the partially substitution of the KOH accelerator solution with NaOH pellets to conserve the modulus ratio at 2.4. However, the rate of dilution of NaOH pellets is much slower than the utilization of any alkali solution with free ions. NaOH pellets need longer time to be dissolved in the distilled water medium to be fully activated or so-called concentrated water for the 1P GP system.

Unlike the other chemical admixtures, the utilization of chemical admixture Z has weight content threshold to reach the highest 1-day UCS of 10 MPa after addition of 0.86 wt % Z to neat recipe W1Pb and then 1-day UCS decreased with higher Z content.

At higher concentrations of ZnO, UCS reduction could be due to the negative action of ZnO on the geopolymeric system, which might affect the condensation process and inhibit the formation of geopolymer gels. The water molecules released during geopolymerization could introduce in reduction potential reaction with ZnO as shown in the following reversable chemical reaction:

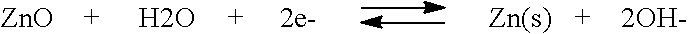

Therefore, the utilization of low concentrations of ZnO can improve the chemical kinetics of geopolymerization reaction to get higher and earlier strength development as observed for the addition of 0.14 wt % equivalent to 24.57 mmol and 0.56 wt % equivalent to 49.14 mmol ZnO to neat recipe W1Pb in FIG. 4.

### 3.2 Nondestructive Compressive Strength

The pregiven algorithms provided by UCA have been developed for OPC and they are not reliable for estimating the strength development of other materials such as one-part rock-based geopolymers.

The estimated sonic strengths showed that the development of algorithms to estimate the sonic strength from transit time is important. The speed of compressional sonic wave is strongly affected by the chemistry of the under-investigated geopolymers.

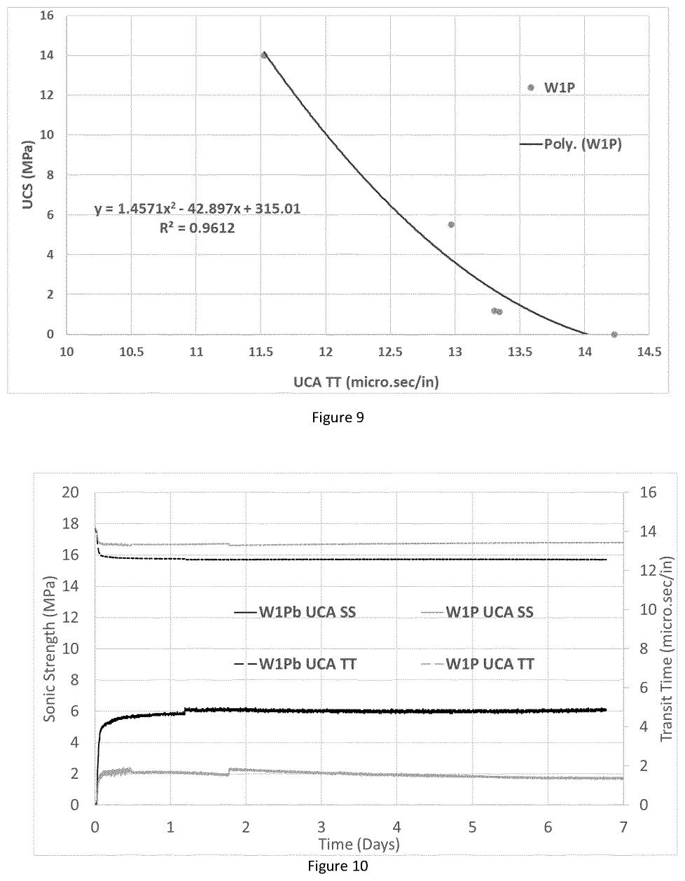

The equation was developed by plotting the average compressive strength values versus measured transit time by the UCA equipment up to 28-days (FIG. 8). A polynomial equation has been generated for the one-part rock-based geopolymers as shown in FIG. 9 and Table 2.

TABLE 2
A polynomial equation for one-part rock-based
geopolymers to estimate SS from TT data.

| Mix | | |
|---|---|---|
| Design | Polynomial equation | R-square value |
| W1P | Y = 211.28X² − 6220X + 45677 | R² = 96.12% |

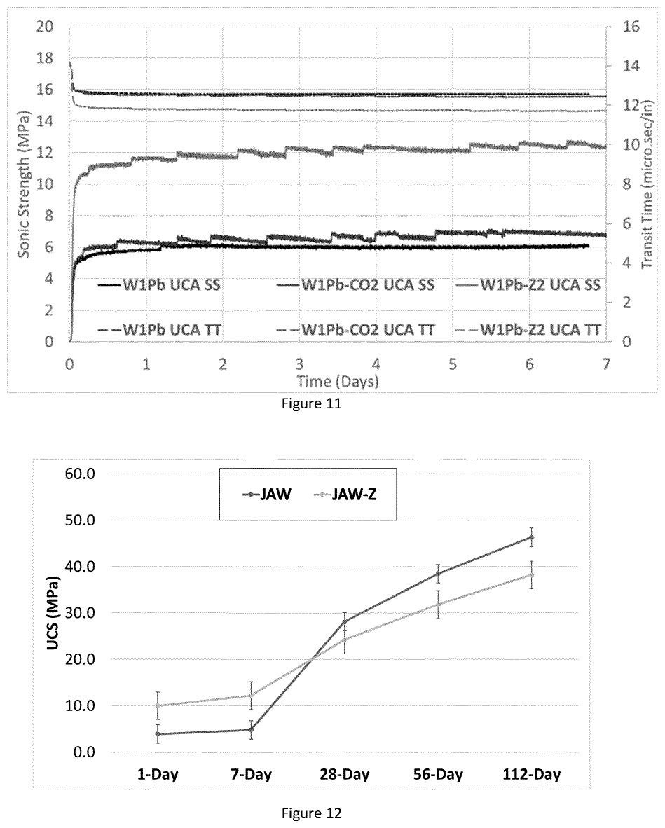

FIG. 10 and FIG. 11 present the sonic strength development curves based on the generated algorithms for W1P recipe as a sonic strength representative for the one-part rock-based geopolymers up to 28 days as shown in FIG. 8.

Table 3 presents setting time at 50 to 500 psi in addition to sonic strength that has been observed after 1- and 7-day.

TABLE 3
Summary of UCA data for the furtherly
investegated 1P GP recipes.

| Mix | Setting Time | Hardening Time | SS (MPa) | SS (MPa) |
|---|---|---|---|---|
| Design | to 50 psi (min) | to 500 psi (min) | for 1-day | for 7-day |
| W1P | 46 | 27540 | 1.68 | 2.11 |
| W1Pb | 40 | 66 | 5.85 | 6.10 |
| W1Pb- | 38 | 60 | 6.22 | 6.74 |
| CO2 | | | | |
| W1Pb- | 37 | 47 | 11.55 | 12.76 |
| Z2 | | | | |

The estimated UCA data are in agreement with the measured UCS values for the top candidate recipes for 1- and 7-day UCS as given in FIGS. 6 & 7 and FIG. 11. From Table 3, W1Pb-Z2 has the shortest time to reach 50 and 500 psi. However, W1P with higher water content has the longest time to reach 50 and 500 psi in which it was taking up to 19 days to reach 500 psi while W1Pb was taking just one hour and six minutes to reach the same sonic strength value. This shows and proves the severe effect of water content on geopolymers as shown in FIG. 10 and Table 3.

Besides, the estimated sonic strength for 1- and 7-day is slightly higher than the measured compressive strength for 1- and 7-day UCS. This could be due the addition of pressure ca. 2000 psi while curing in UCA; however, the UCS samples were cured at ambient pressure.

### 3.3 Composition Analysis, XRD

Generally, geopolymers are known to contain amorphous content especially at low curing temperatures; however, the amorphous content is diminished at elevated curing temperatures.

X-ray diffraction (XRD) showed peaks observed in the spectra of the given geopolymer precursors. It shows the phases originally found in the rock precursors of the granite, GGBFS and microsilica, where granite has high crystalline content up to 80%, however, GGBFS and microsilica have very high amorphous content without any observable crystalline peaks. Granite main peaks correspond to quartz (SiO2), Microcline as an alkali feldspar (KAlSi3O8) and Albite as a plagioclase feldspar (NaAlSi3O8). In addition, the precursor also contains biotite (K(Mg,Fe)3AlSi3O10(F,OH)2). However, Biotite mineral is not found or neglected in the spectra of any of the finished products. Table 4 indicates the computed crystalline and amorphous content for granite, neat recipes, and the investigated chemical admixtures for 1P rock-based GP recipes.

TABLE 4
Crystallinity analysis for 1P GP recipes

| Mix Design | Crystallinity (%) | Amorphicity (%) |
|---|---|---|
| Granite | 79.9 | 20.1 |
| W1P | 52.1 | 47.9 |
| W1Pb | 51.7 | 48.3 |
| W1Pb-CO2 | 53.2 | 46.8 |
| W1Pb-C2 | 50.1 | 49.9 |
| W1Pb-Z2 | 53.0 | 47.0 |

XRD analysis showed similar patterns for the neat samples of the same original composition. XRD showed negligible major changes can be observed over the 7-days of curing and no significant differences were found because of the differences in water content between W1P and W1Pb. Both neat recipes content Quartz, Albite, Microcline, and tracers of Biotite and synthetic potassium aluminum-silicates hydrates (S1), but W1Pb has lower microcline and biotite content than W1P.

The differences in the compositional analysis of W1Pb with the 0.14 wt % chemical additives of Calcium Oxide (CO), Calcium Carbonate (C) and Zinc Oxide (Z) were also analysed with XRD. These W1Pb* modified recipes also have Quartz, Albite and Microcline similar to the W1Pb neat, in addition to three synthetic crystals or hydrates. W1Pb-CO2 has two synthetic hydrates as tracers are Potassium-Sodium-Calcium-Aluminum-Silicate hydrates (S2) and Sodium-Calcium-Magnesium- Aluminum-Silicate hydrates (S3). W1Pb-C2 has tracers of synthetic Sodium-Calcium-Magnesium-Aluminum-Silicate hydrate (S3) only. While, W1Pb-Z2 has just tracers of Potassium Zinc Aluminum-Silicate hydrates (S4).

Two trends were visible in the geopolymer samples. Over time, the composition changes slightly, and the presence of feldspar reduces over time in agreement with and presence of synthetic hydrates as function of each added chemical admixture even if as tracers. For W1P and W1Pb cured at 70° C., there were little peaks of feldspar crystals over the 7-days period of curing. Similarly, W1Pb* recipes also have little trace of feldspar crystals after 7-day of curing, while the main peak of Biotite seemed to be diminished over the 7-days curing.

Therefore, this can suggest a chemical reaction between the geopolymer, chemical admixtures, and the feldspars (Albite and Microcline) present in the precursor. The absence of biotite in all products may also suggest a chemical reaction between the mixtures and biotite, but this absence can also be related to a lesser amount of biotite relative to that total in the final mix, thus making it difficult to differentiate in the XRD spectra.

The results also indicate that different types of feldspar react differently with and without the chemical admixtures put into the geopolymers. In addition, three new synthetic hydrates were observed after the addition of the investigated chemical admixtures (CO, C & Z). However, more data is needed to fully understand these complex chemical processes.

### 5. Example 2

Geopolymer precursor according to example 1 was used, potassium silicate anhydrous powder with modular ratio (MR) 2.4 was utilized as a solid activator. One sample was prepared without the addition of zinc oxide (JAW). Another sample was prepared with the addition of zinc oxide (JAW-Z). Table 5 shows the composition of sample JAW and JAW-Z, respectively.

TABLE 5
Composition of sample JAW and JAW-Z, respectively.

| | Geopolymer | Solid | | |
|---|---|---|---|---|
| Composition (% wt*) | precursor | Activator | ZnO | Water |
| JAW | 59.9 | 15.3 | 0.0 | 24.8 |
| JAW-Z | 59.7 | 15.2 | 0.5 | 24.6 |

*By weight of the total mixture (including both liquid and solid phases) components.

All mixes' and tests for samples JAW and JAW-Z were prepared and performed according to the American Petroleum Institute standards. The solid components of sample JAW were the geopolymer precursor and the solid activator, the solid components of sample JAW-Z were the geopolymer precursor, the solid activator and zinc oxide. The initial preparation of the geopolymer slurries were performed by pre-blending the solid components. The solid mixture was added into a blender containing distilled water. An OFITE Model 20 Constant Speed Blender was used to mix the components into the initial geopolymer slurry. The pre-blended precursor and activator were poured into the distilled water for the first 15 seconds at a shear rate of 4000 rpm. After the initial 1295 seconds, the blender continued to shear for another 35 seconds at 12000 rpm.

All samples were cured at atmospheric pressure in the oven at 70° C. Plastic cylindrical molds and lids were used for curing the samples. A cutter machine was used to flatten both ends of the cured samples. The dimension of the cured samples for uniaxial compressive strength test was about 51 mm diameter and about 80-85 mm height.

Long term uniaxial compressive strength was tested by the strength development profile up to 112 days. The tests were performed in accordance with API 10B-2, Chapter 7. The specimens placed under compression using Toni Technik-H mechanical tester as equipment and the loading rate applied on the samples was 10 kN/min.

### 5. RESULTS AND DISCUSSION

FIG. 12 presents the average uniaxial compressive strength of sample JAW and JAW-Z after 1-day, 7-days, 28-days, 56-days, and 112-days curing period, respectively. Uniaxial compressive strength results show the effect of addition of zinc oxide.

By comparing the uniaxial compressive strength of JAW (dark grey line) and JAW-Z (light grey line) after 1-day curing period, it is seen that JAW-Z exhibits significantly higher strength. Similarly, after 7-days curing period, JAW-Z exhibits significantly higher strength than JAW. The addition of zinc oxide results in higher uniaxial compressive strength after 1-day and 7-days curing.

1. A powder mixture comprising a geopolymer precursor, a zinc oxide and a solid activator selected from MOH, M₂SiO₃ and any combination thereof wherein M is selected from Li, Na and K; wherein the geopolymer precursor is rock based or is a mixture of geopolymer precursors comprising rock based geopolymer.

2. The powder mixture according to claim 1 wherein the amount of geopolymer precursor in the powder mixture is 60-90 wt %, based on the total dry weight of the powder mixture.

3. The powder mixture according to claim 1 wherein the amount of zinc oxide in the powder mixture is 0.05-6 wt %, based on the total dry weight of the powder mixture.

4. The powder mixture according to claim 1 wherein the amount of solid activator in the powder mixture is 10-40 wt %, based on the total dry weight of the powder mixture.

5. The powder mixture according to claim 1 wherein the powder mixture has a weight ratio of zinc oxide and activator to geopolymer precursor of 0.05-0.4, preferably 0.1-0.3, more preferably 0.15-0.25, more preferably 0.18-0.22.

6. The powder mixture according to claim 1 wherein the average particle size of the geopolymeric precursor is ≤100 μm, or preferably ≤63 μm, or more preferably ≤53 μm, more preferably ≤20 μm.

7. The powder mixture according to claim 1 wherein the activator comprises lithium, sodium or potassium silicate with a molar ratio of 2.0-3.9, preferably 2.0-2.5, more preferably around 2.4.

8. The powder mixture according to claim 1 wherein the powder mixture further comprises a solid accelerator is MOH wherein M is selected from Li, Na and K and wherein the concentration of the solid accelerator preferably is in a range of 1-10 wt %, more preferably 2-8 wt % based on the total dry weight of the powder mixture.

9. The powder mixture according to claim 1 wherein the powder mixture is essentially hydrous or anhydrous, more preferable anhydrous.

10. A method of producing a cementitious material comprising:
a. Mixing a geopolymer precursor, a zinc oxide, a solid activator and an aqueous solution to obtain a slurry; wherein the solid activator is selected from MOH, M₂SiO₃, or any combination thereof wherein M is selected from Li, Na and K; wherein the geopolymer precursor is rock based or is a mixture of geopolymer precursors comprising rock based geopolymer;
b. Curing the slurry at a first temperature.

11. The method according to according to claim 9 wherein the method comprises:
a. Providing a powder mixture comprising a geopolymer precursor, a zinc oxide and a solid activator selected from MOH, M₂SiO₃, or a combination there of wherein M is selected from Li, Na or K; wherein the geopolymer precursor is rock based or is a mixture of geopolymer precursors comprising rock based geopolymer;
b. Mixing said powder mixture with an aqueous solution to obtain a slurry; and
c. Curing the slurry at a first temperature.

12. The method according to claim 9 wherein the aqueous solution comprises an accelerator selected from lithium hydroxide, sodium hydroxide and potassium hydroxide or any combination thereof.

13. The method according to claim 10 wherein an accelerator in solid form is added to or mixed with the powder mixture and wherein the accelerator is MOH wherein M is selected from Li, Na and K and wherein the solid accelerator is added or mixed with the powder mixture.

14. The method according to claim 9 wherein the first temperature is 4 to 600° C.

15. The method according to claim 9 wherein the amount of aqueous solution is 20-50 wt % based on the total weight of the dry weight of the powder mixture.

16. A kit comprising at least a first and a second container wherein the first container comprises the powder mixture according to claim 1 and wherein the second container comprises an aqueous solution preferably comprising an accelerator.

17. The kit according to claim 16 wherein the aqueous solution comprises an accelerator selected from lithium hydroxide, sodium hydroxide and potassium hydroxide or any combination thereof, and wherein the concentration of the accelerator preferably is at least 4 M, preferably at least 10 M, more preferably at least 12 M.

18. The kit according to claim 16 wherein the amount of aqueous solution is 20-50 wt % based on the total weight of the dry weight of the powder mixture.

19. The powder mixture according to claim 1 wherein the amount of geopolymer precursor in the powder mixture is 70-85 wt % based on the total dry weight of the powder mixture

20. The powder mixture according to claim 1 wherein the amount of zinc oxide in the powder mixture is 0.08-3 wt % based on the total dry weight of the powder mixture.

21. The powder mixture according to claim 1 wherein the amount of solid activator in the powder mixture is 10-25wt % based on the total dry weight of the powder mixture.

22. The powder mixture according to claim 1 wherein the powder mixture has a weight ratio of zinc oxide and activator to geopolymer precursor of 0.1-0.3, more preferably 0.15-0.25, more preferably 0.18-0.22.

23. The powder mixture according to claim 1 wherein the powder mixture has a weight ratio of zinc oxide and activator to geopolymer precursor of 0.18-0.22.

24. The powder mixture according to claim 1 wherein the average particle size of the geopolymeric precursor is ≤53 μm.

25. The powder mixture according to claim 1 wherein the activator comprises lithium, sodium or potassium silicate with a molar ratio of 2.0-2.5.

26. The powder mixture according to claim 8 wherein the concentration of the solid accelerator preferably is in a range of 1-10 wt % based on the total dry weight of the powder mixture.

27. The kit according to claim 17 wherein the concentration of the accelerator is at least 4 M.
